(19) United States
(12) Patent Application Publication
(10) Pub. No.: US 2024/0111586 A1
(43) Pub. Date: Apr. 4, 2024

(54) MULTI-POLICY INTELLIGENT SCHEDULING METHOD AND APPARATUS ORIENTED TO HETEROGENEOUS COMPUTING POWER

(71) Applicant: ZHEJIANG LAB, Hangzhou City (CN)

(72) Inventors: Shiqiang ZHU, Hangzhou City (CN); Aimin PAN, Hangzhou City (CN); Feng GAO, Hangzhou City (CN)

(73) Assignee: ZHEJIANG LAB, Hangzhou City, ZJ (CN)

(21) Appl. No.: 18/472,648

(22) Filed: Sep. 22, 2023

Related U.S. Application Data
(63) Continuation of application No. PCT/CN2023/085526, filed on Mar. 31, 2023.

(30) Foreign Application Priority Data
Sep. 21, 2022 (CN) 202211148225.2

(51) Int. Cl. G06F 9/50

(52) U.S. Cl. CPC G06F 9/5027

(57) ABSTRACT

The present disclosure belongs to the field of intelligent computing technologies, and relates to a multi-policy intelligent scheduling methods and apparatuses oriented to heterogeneous computing power. The method includes: step 1, setting an execution policy of a task based on heterogeneity of computing clusters, differences of computing tasks and a user requirement, and constructing a Markov decision process model by adopting a reinforcement learning method combined with the execution policy; step 2, adopting a proximal policy optimization to solve an optimal task scheduling policy of the task input by the user based on the constructed Markov decision process model; step 3, scheduling the task to a corresponding computing cluster for execution based on the optimal task scheduling policy.

### CROSS-REFERENCE TO RELATED APPLICATION

The present application is a continuation application of International Application No. PCT/CN2023/085526 filed on Mar. 31, 2023, which claims a priority of the Chinese patent application No. 202211148225.2 filed on Sep. 21, 2022, which is incorporated herein by reference in its entirety.

### TECHNICAL FIELD

The present disclosure belongs to the field of intelligent computing technologies, and relates to multi-policy intelligent scheduling methods and apparatuses oriented to heterogeneous computing power.

### BACKGROUND

Computing power has become one of core engines to stimulate economic growth. The so-called “computing power” refers to computing power of a device to output specific results by processing data. William Nordhaus, the winner of the Nobel Memorial Prize in Economic Sciences in 2018, put forward in the article “The Progress of Computing” that “computing power is defined as the amount of information delivered per second by the machine—that is, the quantity of information produced as the machine moves from one internal state to another.” From a chip, a mobile phone and a PC to a self-driving car, an Internet, an artificial intelligence (AI) and a data center, computing power plays a fundamental and core role. Without computing power, there would be no information systems.

Computing power is a synthesis of computing, storage and network capabilities. It is a platform for carrying data and computing operations on a micro level and an important part of information infrastructure in digital economy era on a macro level. As one of the three elements of AI technology: data, computing power and algorithm, computing power also plays a key role in intelligent computing. For example, in a “smart city” scenario, a massive remote sensing image sample data cannot be separated from AI large-scale computing power. Based on the AI large-scale computing power, it has the ability to find problems in time and efficiently verify in urban illegal construction governance and ecological environment monitoring.

In order to balance cost and benefit, a user may have a requirement to use different execution policies for different tasks when using computing power. User execution policies include minimum cost, minimum bandwidth usage, minimum computing time, etc., and the user can choose an appropriate policy to execute an assignment according to the characteristics of the assignment. However, at present, most scheduling policies are mostly from the perspective of resources to achieve load balance or optimal resource utilization, and rarely take into account the user's computing requirement.

### SUMMARY

In order to solve the above technical problems in the prior art, the present disclosure proposes multi-policy intelligent scheduling methods and apparatuses oriented to heterogeneous computing power, with the following specific technical solutions:
a multi-policy intelligent scheduling method oriented to heterogeneous computing power, performed by an operating system kernel of a host machine, including following steps:
step 1, setting an execution policy of a task based on heterogeneity of computing clusters, differences of computing tasks and a user requirement, and constructing a Markov decision process model by adopting a reinforcement learning manner combined with the execution policy;
step 2, adopting a proximal policy optimization to solve an optimal task scheduling policy of the task input by the user based on the constructed Markov decision process model; and
step 3, scheduling the task to one or more corresponding clusters for execution based on the optimal task scheduling policy.

Furthermore, the computing clusters include one or more intelligent computing clusters, one or more high-performance computing clusters and one or more terminal idle computing cluster, the computing clusters include virtualized container clusters, a collection of the computing clusters is marked as C={C₀, C₁, . . . , C_{K}}, where C₀ represents a computing resource scheduling cluster, Cₖ(1≤k≤K) represents a cluster that performs the computing task, K represents a number of the computing clusters, each cluster Cₖ includes a limited number nₖ of containers c, and Cₖ={c₁, c₂, . . . , cₙ_{ₖ}} represents a set of containers c which can be configured in available resources.

Furthermore, a set of the tasks is T={t₀, t₁, . . . , t_{N}}, where N is a total number of tasks in a time period, for any task tᵢϵT and for a container cₖϵCₖ located in Cₖ, cₖ=map(tᵢ), which indicates the task tᵢ is executed by the container cₖ, in response to determining that the container cₖ has been deployed, the task tᵢ is executed directly, in response to determining that the container cₖ has not been deployed, then cₖ=Ø, and a corresponding mirroring file is acquired from a mirroring repository of a container and starting the container.

Furthermore, the task tᵢ is marked as tᵢ={atᵢ, wtᵢ, dlᵢ dsᵢ, cᵢ^{k}}, where atᵢ represents an arrival time of the task the task tᵢ, wtᵢ represents a waiting time of task, dlᵢ represents an execution duration of the task tᵢ, whose value is −1 in response to determining no duration existing; dsᵢ represents data to be processed by the task tᵢ, cᵢ^{k} represents a set of containers on a kth cluster required by the task; and an execution time of the task tᵢ is:

$$e {t}_{i}^{k} = \frac{d {s}_{i}}{E {R}_{{c}_{i}^{k}}}$$

where etᵢ^{k} represents the execution time of the task tᵢ, which is obtained by the data amount dsᵢ corresponding to the task divided by a total processing rate ER_{c}_{ᵢ}_{^{k}} of data by an algorithm in the set of containers cᵢ^{k}, to obtain the execution time of the task tᵢ;
for a case of dlᵢ>0, a constraint is:

dlᵢ−atᵢ>wtᵢ+etᵢ^{k}.

Furthermore, the Markov decision process model, combined with the execution policy, is represented by five elements (S, A, P, R, γ) of reinforcement learning manner, where S represents state space, A represents action space, P represents state transition matrix, R represents reward function, and γ represents discount factor; the state space is used to reflect the state of the computing cluster; the action space is used to represent scheduling of one or more current tasks; the state transfer matrix is composed of probabilities of all state transfers in the state space according to actions of the action space in the Markov decision process model; the reward function is used to reflect the execution policies of different tasks and is set based on the execution policies; the discount factor takes values between 0 and 1, the Markov decision processes model considers both the current rewards and future rewards, and the discount factor represents that the more the future rewards, the greater the discount and the smaller the corresponding weight.

Furthermore, the execution policies include: a least cost policy, a shortest execution time policy, an optimal energy consumption policy and an optimal bandwidth policy;
the reward function specifically includes:
an expression of a reward function for executing the least cost policy is:

$${r}_{n}^{1} = \frac{1}{1 + {e}^{\frac{{t}_{n}^{1}}{max \{ {t}_{n}^{1} \}}}}$$

where a cost function is:

tₙ¹=dsᵢ×f_{c}^{k}+etₙ^{k}×fᵤ^{k}×rateᵢ;
where at a nth stage of a training period, tₙ¹ represents an operating cost of a subtask at the stage, including two parts: communication cost and computing cost, the communication cost is set as processed amount of data dsᵢ multiplied by a cost of unit data f_{c}^{k} of the cluster Cₖ, and the computing cost is an execution time etₙ^{k} multiplied by a cost of unit data fᵤ^{k} of the cluster Cₖ and then multiplied by a resource occupancy rate rateᵢ; where, when a cost is higher, an obtained reward is less, the reward function rₙ¹ for stage n represents a monotonically decreasing function of tₙ¹;
where an expression of a reward function for executing the shortest time execution policy is:

$${r}_{n}^{2} = \frac{1}{1 + {e}^{\frac{{t}_{n}^{2}}{max \{ {t}_{n}^{2} \}}}}$$

where a cost function is:

tₙ²=wtₙ+etₙ^{k};
where at a nth stage in a period, tₙ² represents that a running time of the subtask, which is equal to a sum of a waiting time wtₙ and an execution time etₙ^{k}; where the running time is longer, the obtained reward is less, so the reward function rₙ² of stage n represents a monotonically decreasing function of tₙ²;
where an expression of a reward function for executing the optimal energy consumption policy is:

$${r}_{n}^{3} = \frac{1}{1 + {e}^{\frac{{t}_{n}^{3}}{max \{ {t}_{n}^{3} \}}}}$$

where a cost function is:

$${t}_{n}^{3} = c {p}_{n}^{k} + g {p}_{n}^{k}$$

$${cp}_{n}^{k} = {\sum }_{i ∈ H ( k )} s c {p}_{i} \times {c\_rate}_{i}$$

$${gp}_{n}^{k} = {\sum }_{i ∈ H ( k )} s g {p}_{i} \times {g\_rate}_{i} ;$$

where at a nth stage in a period, tₙ³ represents that a subtask energy consumption assessment, which is equal to a sum of a CPU energy consumption assessment cpₙ^{k} and a GPU energy consumption assessment gpₙ^{k}; CPU or GPU power consumption refers to CPU power consumption scpᵢ or GPU power consumption sgpᵢ of a server running the subtask within the cluster Cₖ multiplied by an average occupancy rate c_rateᵢ or g_rateᵢ; when a power consumption is higher, the obtained reward is less, the reward function rₙ³, for stage n is a monotonically decreasing function of tₙ³; and
where an expression of a reward function for executing the optimal bandwidth policy is:

$${r}_{n}^{4} = \frac{1}{1 + {e}^{\frac{{t}_{n}^{4}}{max \{ {t}_{n}^{4} \}}}}$$

where a cost function is:

$${t}_{n}^{4} = {\sum }_{k > j} \frac{{ds}_{kj}}{{et}_{j}^{n}} ;$$

where dsₖⱼ indicates an amount of data transmitted from cluster Cₖ to cluster Cⱼ at stage n, etⱼⁿ represents an average computing time of cluster Cⱼ at the stage n, and an obtained rₙ⁴ represents average transmission bandwidth; when a power consumption is higher, the obtained reward is less, the reward function rₙ⁴ for stage n is a monotonically decreasing function of tₙ⁴.

Furthermore, the proximal policy optimization is based on a policy gradient method, and by introducing dominance function and importance sampling, updating a gradient as:

$$∇ \overline{R} = {E}_{τ \sim {p}_{{θ}^{′} ( τ )}} [ \frac{{p}_{θ}}{{p}_{{θ}^{′}}} A ] = {\sum }_{t = 1}^{T} \frac{{p}_{θ} ( {a}_{t} \vert {s}_{t} )}{{p}_{{θ}^{′}} ( {a}_{t} \vert {s}_{t} )} {A}_{t} ( {a}_{t} \vert {s}_{t} )$$

where the dominance function is:

$${A}_{t} ( {a}_{t} \vert {s}_{t} ) = {\sum }_{{t}^{′} > t} {γ}^{{t}^{′} - t} {r}_{{t}^{′}} - {V}_{∅} ( {s}_{t} ) .$$

where

$${\sum }_{{t}^{′} > t} {γ}^{{t}^{′} - t} {r}_{{t}^{′}}$$

represents a total discount reward after an action point in a sequence collected data; V_{Ø}(sₜ) represents an evaluation of a state sₜ by a Critic network, where the Critic network is used to estimate a total amount that obtained from the state sₜ to the end; and aₜ is an execution policy corresponding to the state sₜ.

Furthermore, a training of the proximal policy optimization adopts following three neural networks:
a neural network Actor-new with a parameter θ, which is responsible for interacting with environment to collect batch data, and then associating the batch data with a copy of θ for each update;
a neural network Actor-old with a parameter θ′, includes correlation parameters of a policy parameter and data collected after interaction with the environment, which is equivalent to a q distribution in importance sampling; and
the evaluation neural network Critic with a parameter Ø, which updates an evaluation of a state by supervised learning based on the collected data.

Furthermore, the step 3 is specifically: scheduling the task to one or more waiting queues of the one or more corresponding computing clusters based on the optimal task scheduling policy, checking whether there is the corresponding computing cluster, in response to determining that the corresponding computing cluster exists, executing according to a corresponding queue, and in response to determining that the corresponding computing cluster does not exist, downloading a corresponding mirroring image of the computing cluster from the mirroring repository and starting to execute according to the corresponding queue.

A multi-policy intelligent scheduling apparatus oriented to heterogeneous computing power, including one or more processors, configured to realize the multi-policy intelligent scheduling method oriented to heterogeneous computing power.

Beneficial effect: the present disclosure is a user-centered scheduling method that designs heterogeneous computing power and builds multiple policies by means of reinforcement learning, which can self-learning an optimal task scheduling solution based on states of heterogeneous computing power clusters in different computing power centers, so as to improve the utilization of computing power in a cost-effective way and meet the requirements of users to solve tasks.

### BRIEF DESCRIPTION OF DRAWINGS

FIG. 1 is a flowchart of a multi-policy intelligent scheduling method oriented to heterogeneous computing power in the present disclosure;

FIG. 2 is a schematic diagram of a system architecture oriented by a method embodiment of the present disclosure;

FIG. 3 is a detailed scheduling flowchart of a multi-policy intelligent scheduling method oriented to heterogeneous computing power of the present disclosure;

FIG. 4 is a schematic structural diagram of a multi-policy intelligent scheduling apparatus oriented to heterogeneous computing power in an embodiment of the present disclosure.

### DETAILED DESCRIPTION

In order to make the purpose, technical solution and technical effect of the present disclosure more clear, the present disclosure will be further explained in detail with the accompanying drawings and examples in the specification.

In order to facilitate the understanding of embodiments of the present disclosure, the terms involved in the embodiments of the present disclosure are first explained.

Container: by combining lightweight application isolation and image-based deployment methods, the application and other binary files needed for its operation are packaged together, thus providing an independent operating system environment for the application. An architecture of a container includes a container, a container execution engine (e.g., RunC), and a container image. The container shares underlying physical machine resources of a host machine. There is no independent operating system kernel in the container, and the container uses the operating system kernel of the host machine. The container is configured to encapsulate the application and provide a runtime environment for the application. RunC provides configuration files for running container instances. The container image, which is a read-only static template, saves the environment needed by the container and execution codes of the application.

Virtualized container: a container based on hardware virtualization technology. An architecture of the virtualized container includes a virtualized container, a virtualized container execution engine (e.g., runV), a container image, Hypervisor middle layer(s) and a guest kernel. RunV is an engine of container runtime based on virtualization technology determined by open container intiative (OCI), and runV provides configuration files for running virtualized container instances. The virtualized container is configured to encapsulate the application and provide a runtime environment for the applications. The virtualized container is also known as a container virtual machine, is a virtualized container based on Hypervisor that combines advantages of container and virtual machine, and can run the execution engine of container image directly on hypervisor without installing a complete operating system.

Host machine: refers to a host or a server that hosts virtual machines and manages virtual environments in virtualization technology. Its main function is to allocate physical computer resources to virtual machines.

Therefore, a virtualized container-based system is a virtualized environment including one or more containers and one or more host machines created by container-based virtualization technology. Containers effectively divide resources managed by a single operating system into isolated groups to better balance conflicting resource usage requirements among isolated groups. Compared with traditional virtualization technology, container-based virtualization technology has the advantages of using the same kernel as the host machine, low performance loss and no instruction-level simulation.

Current scheduling policies of computing power resources only take available amount of computing power resources (such as available cores, memory, cards, etc.) as a scheduling weight. However, in practical applications, different tasks have different execution policy requirements. Therefore, a scheduling policy that schedules computing power based on resources cannot meet a multi-dimensional computing requirements such as cost, bandwidth usage and computing time. Based on the problems existing in the current scheduling methods of computing power resources, embodiments of the present disclosure provide a multi-policy intelligent scheduling method oriented to heterogeneous computing power, so as to meet user's computing requirements in smart city and other fields.

A computing cluster is a shared computing environment composed of servers (nodes), in which resources are centralized to support workloads and processes running in a cluster. When processes (called tasks) in the cluster are grouped together, they create solutions, including grouping tasks into an assignment.

To achieve this, a cluster management framework is needed to manage the clusters, which usually includes a resource manager to track resources (e.g., memory, CPU and storage). When resources are needed to perform tasks, they must be acquired via the resource manager. Having well management to access of resources means that an impact on a platform can be managed, so that a whole system can be expanded virtually or physically.

Other components of the cluster management framework include, for example, a task manager responsible for task execution and state management. The cluster management framework further includes a scheduler, which is responsible for managing dependencies between the tasks that make up the assignment and distributing the tasks to the nodes. The scheduler is a core component of the cluster management framework.

A container cluster is a dynamic system of container management that places and manages containers, grouped in some forms, and running on nodes. It also manages all of the interconnections and communication channels that connect the containers within the system.

As shown in FIG. 1, a multi-policy intelligent scheduling method oriented to heterogeneous computing power is provided by the present disclosure, which constructs different reward functions to realize multi-policy scheduling mechanism based on proximal policy optimization (PPO), thereby realizing an optimal scheduling solution under different policies. Specifically, the method includes the following step 1 to step 3.

At step 1, an execution policy of a task is set based on heterogeneity of computing clusters, differences of computing tasks and a user requirement, and a Markov decision process (MDP) model is constructed by adopting a reinforcement learning manner combined with the execution policy.

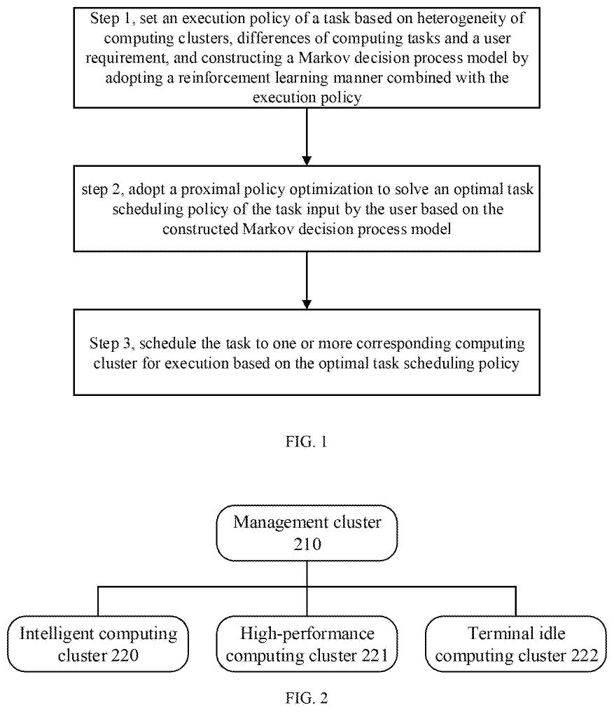

Specifically, as shown in FIG. 2, an architecture oriented by an embodiment of the present disclosure may include an operating system cluster and a plurality of computing clusters. The operating system cluster is also referred to as management cluster 210, and the plurality of computing clusters may include intelligent computing cluster 220, high-performance computing cluster 221, and terminal idle computing cluster 222. Assuming that the computing clusters are virtualized container clusters, a container of which has the characteristics of fast startup and operation, fast packaging and deployment, and less resource consumption. A set of computing clusters can be denoted as C={C₀, C₁, . . . , C_{K}}, where C₀ represents a computing resource scheduling cluster, Cₖ(1≤k≤K) represents a cluster that performs the computing task, and K represents the number of the computing clusters. Each cluster Cₖ includes a limited number of nₖ of containers c, and Cₖ={c₁, c₂, . . . , cₙ_{ₖ}} represents a set of containers in which available resources can be configured.

Set the execution policy of the task based on the user requirement includes any one of the following: a least cost policy, a shortest execution time policy, an optimal energy consumption policy and an optimal bandwidth policy. Then a series of computing tasks are submitted, where the set of tasks can be defined as T={t₀, t₁, . . . , t_{N}}, where N represents a total number of tasks in a time period. Each task submits a series of subtasks, and the subtasks enter a waiting queue first. If the system has an idle and adaptive container, the task can be assigned to run by a corresponding container. For any task tᵢϵT and for a container cₖϵCₖ, i.e., cₖ located in cluster Cₖ, cₖ=map(tᵢ), which indicates the task tᵢ is executed by the container cₖ. If the container cₖ has been deployed, the task tᵢ can be executed directly. If the container cₖ has not been deployed, cₖ=Ø, and it is necessary to acquire a corresponding mirroring file from a mirroring repository of the container and starting the container.

The task tᵢ is marked as tᵢ={atᵢ,wtᵢ, dlᵢ dsᵢ, cᵢ^{k}}, which includes associated information for each executed task, where atᵢ represents an arrival time of the task tᵢ, wtᵢ represents a waiting time of the task tᵢ, dlᵢ represents an execution duration of the task tᵢ, whose value is −1 if there is no duration; dsᵢ represents data to be processed by the task tᵢ, and cᵢ^{k} represents a set of containers on a k-th cluster required by the task tᵢ. An execution time of the task tᵢ is:

$$e {t}_{i}^{k} = \frac{d {s}_{i}}{E {R}_{{c}_{i}^{k}}}$$

where etᵢ^{k} represents the execution time of the task tᵢ, which is obtained by the data amount dsᵢ corresponding to the task dividing by a total processing rate ER_{c}_{ᵢ}_{^{k}} of data by an algorithm in the set of containers cᵢ^{k}.

Obviously, for a case of dlᵢ>0, a constraint is:

dlᵢ−atᵢ>wtᵢ+etᵢ^{k}.

The user submits a task request. A most suitable cluster is selected to execute the task according to the set execution policy and state information of computing clusters, and state information of different clusters is collected to prepare for a scheduling of the next task. A construction of Markov decision process model is thus completed. The Markov decision process model may be represented by five elements (S, A, P, R, γ) of the reinforcement learning manner, in which S represents a state space, A represents an action space, P represents a state transfer matrix, R represents a reward function, and γ represents a discount factor.

Specifically, with respect to the state space S, the state space of the present disclosure is used to reflect a state of the clusters, which is a basis for executing a scheduling decision and an input of a scheduling algorithm. The state space S of the MDP model can comprehensively and objectively reflect an operation of a current system.

The energy consumption indicator is an important status indicator of a cluster. The energy consumption of the cluster is a sum of energy consumption of each different server, and energy consumption of a server mainly includes energy consumption of Central Processing Unit (CPU) and Graphics Processing Unit (GPU). Power consumption of CPU and GPU is positively correlated with their utilization rates, and by acquiring their utilization rates, container-related energy consumption can be inferred.

For the action space A, the present disclosure defines a decision to assign one or more computing tasks as an action in an action space, indicating to which server(s) the computing task(s) is about to be assigned:

A={0,1,2, . . . ,K}
where action “0” indicates that a current task cannot be scheduled, and there is no action if the scheduling fails. Other values represent a serial number of a cluster which is determined to be optimal, such as the action “1” meaning selecting a cluster with the number “1” to complete the computing task.

For the state transfer matrix P, in the MDP (Markov Decision Process) model, because of the action in the action space, a probability of transferring from state s to another state s′ is defined as a state transfer probability, and all state transfer probabilities in the state space constitute the state transfer matrix:

Pₐ(s,s′)=P(Sₙ₊₁=s′|sₙ=s,aₙ=a)

Regarding the reward function R, which is different from a usual single reward function, the present disclosure reflects different task execution policies, namely user policies, through four reward functions, as follows:
an expression of a least cost policy is:

$${r}_{n}^{1} = \frac{1}{1 + {e}^{\frac{{t}_{n}^{1}}{max \{ {t}_{n}^{1} \}}}} ;$$

where a cost function is:

tₙ¹=dsᵢ×f_{c}^{k}+etₙ^{k}×fᵤ^{k}×rateᵢ;

where, at a n-th stage of a period, tₙ¹ represents an operating cost of a subtask at the stage, including two parts: communication cost and computing cost, the communication cost is set as processed amount of data dsᵢ multiplied by a cost of unit data f_{c}^{k} of the cluster Cₖ, and the computing cost is an execution time multiplied by a cost of unit data fᵤ^{k} of the cluster Cₖ and then multiplied by a resource occupancy rate rateᵢ. Due to the higher the cost, the less the reward obtained, the reward function rₙ¹ for stage n is a monotonically decreasing function of tₙ¹.

An expression of a shortest execution time policy is:

$${r}_{n}^{2} = \frac{1}{1 + {e}^{\frac{{t}_{n}^{2}}{max \{ {t}_{n}^{2} \}}}} ;$$

where a cost function is:

tₙ²=wtₙ+etₙ^{k};
where at a n-th stage in a period, tₙ² represents that a running time of the subtask, which is equal to a sum of a waiting time and an execution time. Due to the longer the running time, the less the reward obtained, so the reward function rₙ² of stage n is a monotonically decreasing function of tₙ².

An expression of an optimal energy consumption is:

$${r}_{n}^{3} = \frac{1}{1 + {e}^{\frac{{t}_{n}^{3}}{max \{ {t}_{n}^{3} \}}}} ;$$

where a cost function is:

$${t}_{n}^{3} = c {p}_{n}^{k} + g {p}_{n}^{k}$$

$${cp}_{n}^{k} = {\sum }_{i ∈ H ( k )} s c {p}_{i} \times {c\_rate}_{i}$$

$${gp}_{n}^{k} = {\sum }_{i ∈ H ( k )} s g {p}_{i} \times {g\_rate}_{i} ;$$

where at a n-th stage in a period, tₙ³, represents that a subtask energy consumption assessment, which is equal to a sum of a CPU energy consumption assessment and a graphics processing unit (GPU) energy consumption assessment; and CPU (or GPU) power consumption refers to CPU power consumption scpᵢ (or GPU power consumption sgpᵢ) of a server running the subtask within the cluster Cₖ multiplied by an average occupancy rate c_rateᵢ (or g_rateᵢ). Due to the higher the power consumption, the lower the reward obtained, the reward function rₙ³, for stage n is a monotonically decreasing function of tₙ³.

An expression of an optimal bandwidth policy is:

$${r}_{n}^{4} = \frac{1}{1 + {e}^{\frac{{t}_{n}^{4}}{max \{ {t}_{n}^{4} \}}}} ;$$

where a cost function is:

$${t}_{n}^{4} = {\sum }_{k > j} \frac{{ds}_{kj}}{{et}_{j}^{n}} ;$$

where dsₖⱼ indicates the amount of data transmitted from cluster Cₖ to cluster Cⱼ at stage n, etⱼⁿ represents an average computing time of cluster Cⱼ at stage n, and an obtained rₙ⁴ represents average transmission bandwidth. Due to the larger the bandwidth, the less the reward obtained, the reward function rₙ⁴ for stage n is a monotonically decreasing function of tₙ⁴.

rₙ⁽ⁱ⁾ represents a reward function under the four policies of the present disclosure.

For a discount factor γ, the MDP model not only considers a current reward, but also wants to consider future rewards. Due to the randomness of the environment, it is more reasonable to reduce the proportion of future rewards. Within N steps of a training period of the system, a return function at n stage is:

$$\\ {R}_{n}^{( i )} = {r}_{n}^{( i )} + γ {r}_{n + 1}^{( i )} + {γ}^{2} {r}_{n + 2}^{( i )} + … + {γ}^{N - n} {r}_{N}^{( i )} , i = 1 , 2 , 3 , 4$$

the discount factor γ takes a value between 0 and 1, indicating that the more future the reward, the greater the discount and the smaller the corresponding weight.

At step 2, a PPO is adopted to solve an optimal task scheduling policy of the task input by the user based on the constructed MDP model.

There are usually two kinds of reinforcement learning: value-based learning method and policy-based learning method. The value-based learning method cannot guarantee that the solution process must converge, while the policy-based learning method will also lead to slow convergence due to large variance in gradient estimation.

Proximal policy optimization adopted in the embodiments of the present disclosure is an improved algorithm for policy gradient. The PPO transforms the On-policy training process in the policy gradient into Off-policy by the method of importance sampling, so that the sampled data (especially important data) can be reused.

After each parameter update, the policy gradient method needs to interact with the environment again to collect data, and then use the data to update. The collected data can only be used once at a time, which makes the parameter update of neural network slow and the convergence time long. Therefore, the improved PPO model training method is to reuse the collected data. Assuming that policy parameter(s) used in data collection represents as θ′, the collected data are saved as a sequence τ at this time. Once the sequence is long enough, the parameter(s) is updated according to a policy gradient manner, and the parameter(s) of the updated policy is changed from θ′ to θ, at this time, corresponding to the policy gradient manner, the data should be re-collected with the policy of parameter θ, but the old data are reused in the PPO to update θ for multiple times. It is noted that the data should be collected based on the policy of θ, but actually the data is collected under θ′, so importance sampling needs to be introduced to correct a deviation between the two.

By introducing dominance function and importance sampling, the gradient is updated as follows:

$$\\ ∇ \overline{R} = {E}_{τ \sim {p}_{{θ}^{′} ( τ )}} [ \frac{{p}_{θ}}{{p}_{{θ}^{′}}} A ] = {\sum }_{t = 1}^{T} \frac{{p}_{θ} ( {a}_{t} \vert {s}_{t} )}{{p}_{{θ}^{′}} ( {a}_{t} \vert {s}_{t} )} {A}_{t} ( {a}_{t} \vert {s}_{t} )$$

where the dominance function is:

$$\\ {A}_{t} ( {a}_{t} \vert {s}_{t} ) = {\sum }_{{t}^{′} > t} {γ}^{{t}^{′} - t} {r}_{{t}^{′}} - {V}_{∅} ( {s}_{t} ) ;$$

where the first half

$$\\ {\sum }_{{t}^{′} > t} {γ}^{{t}^{′} - t} {r}_{{t}^{′}}$$

of the equation represents a total discount reward after an action point in a sequence τ in collected data; V_{Ø}(sₜ) represents an evaluation of a state by a Critic network, so the Critic network can be seen as a supervisory network for estimating a total amount that can be obtained from a state sₜ to the end, which is equivalent to an evaluation of the state sₜ. From another point of view, V_{Ø}(sₜ) can also represent an expectation of a subsequent discounted rewards of the state sₜ, aₜ represents an execution policy corresponding to state sₜ.

The solution of the PPO algorithm relies on trainings of three neural networks as follows:
a neural network Actor-new with a parameter θ, which is responsible for interacting with environment to collect batch data, and then associating the batch data with a copy of θ, which is updated every time;
a neural network Actor-old with a parameter θ′, includes correlation parameters of a policy parameter and data collected after interaction with the environment, which is equivalent to a q distribution in importance sampling; and
an evaluation neural network Critic with a parameter Ø, which updates an evaluation of a state by supervised learning based on the collected data.

At step 3, the task is scheduled to one or more corresponding computing clusters for execution based on the optimal task scheduling policy.

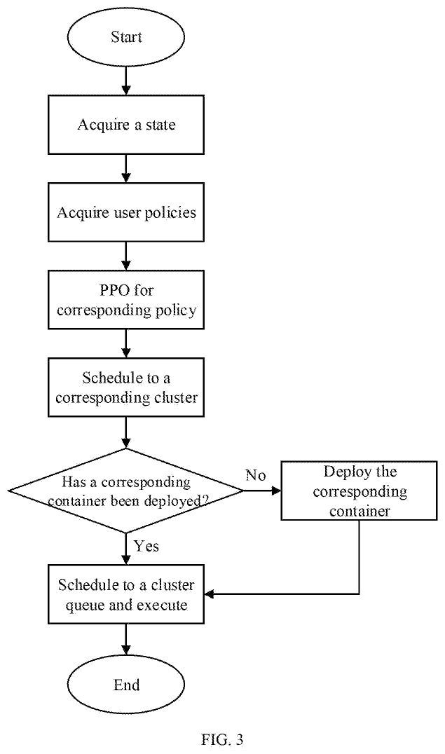

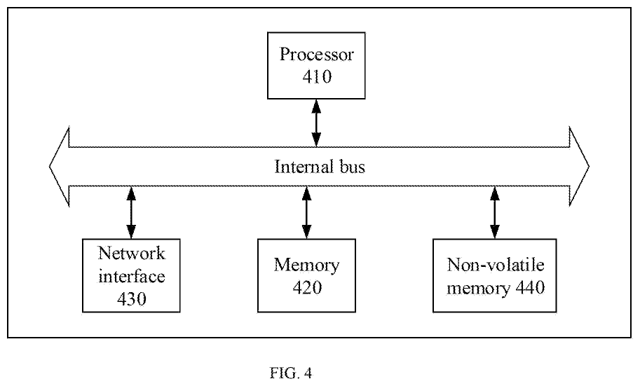

As shown in FIG. 3, according to the state when the task arrives and the execution policy set by the user, the present disclosure adopts PPO to solve the scheduling decision through MDP model, and schedules the task to one or more waiting queues of the one or more corresponding cluster according to the scheduling decision, and checks whether there is a corresponding container, if the corresponding container exists, it is executed according to a corresponding queue, and if not, it downloads a corresponding mirroring image of the containers from the mirroring repository and starts to execute according to the corresponding queue.

In the embodiments of the present disclosure, the optimal task scheduling policy includes a policy that meets the needs of users to solve computing tasks in smart city scenarios. In the smart city scenarios, it may be necessary to calculate massive remote sensing image sample data acquired from urban illegal construction governance, ecological environment monitoring, and other aspects.

Corresponding to the aforementioned embodiments of a multi-policy intelligent scheduling method oriented to heterogeneous computing power, the present disclosure further provides an embodiment of a multi-policy intelligent scheduling apparatus oriented to heterogeneous computing power.

Referring to FIG. 4, an embodiment of the present disclosure provides a multi-policy intelligent scheduling apparatus oriented to heterogeneous computing power, including one or more processors 410, configured to realize the multi-policy intelligent scheduling method oriented to heterogeneous computing power in the aforementioned embodiments.

Embodiments of a multi-policy intelligent scheduling apparatus oriented to heterogeneous computing power in the present disclosure can be applied to any device with data processing capability, which can be a device or apparatus such as a computer. Embodiments of the apparatus can be realized by software, or by hardware or a combination of hardware and software. Taking realized by software as an example, as an apparatus in the logical sense, is formed by reading corresponding computer program instructions from non-volatile memory into memory and running them through the processor of any device with data processing capability in which it is located. At a hardware level, as shown in FIG. 4, it is a hardware architecture diagram of any device with data processing capability where a multi-policy intelligent scheduling apparatus oriented to heterogeneous computing power is located of the present disclosure. In addition to a processor 410, a memory 420, a network interface 430 and anon-volatile memory 440 shown in FIG. 4, any device with data processing capability where the apparatus is located in the embodiment usually includes other hardware according to the actual functions of the any device with data processing capability, which will not be described here again.

The process of realizing the functions and roles of each unit in the above apparatus is detailed in the process of realizing the corresponding steps in the above method and will not be repeated here.

For the apparatus embodiment, because it basically corresponds to the method embodiment, it is only necessary to refer to the method embodiment for the relevant part of the description. The apparatus embodiments described above are only schematic, in which the units described as separate components may or may not be physically separated, and the components displayed as units may or may not be physical units, that is, they may be located in one place or distributed to multiple network units. Some or all of the modules can be selected according to actual needs to achieve the purpose of the solution of the present disclosure. It can be understood and implemented by a person of ordinary skill in the art without creative labor.

Embodiments of the present disclosure further provides a computer-readable storage medium, on which a program is stored, which, when executed by a processor, realizes a multi-policy intelligent scheduling method oriented to heterogeneous computing power in the above embodiments.

The computer-readable storage medium can be an internal storage unit of any device with data processing capability described in any of the previous embodiments, such as a hard disk or a memory. The computer-readable storage medium can also be an external storage device, such as a plug-in hard disk, smart media card (SMC), SD card, flash card, etc. provided on the device. Further, the computer-readable storage medium can further include both internal storage units and external storage devices of any device with data processing capability. The computer-readable storage medium is configured to store the computer program and other programs and data required by any equipment with data processing capability, and can further be configured to temporarily store data that has been output or will be output.

The foregoing is only part of embodiments of the present disclosure and is not intended to limit the present disclosure in any way. Although the process of implementing the present disclosure has been described in detail in the preceding paragraphs, it is still possible for a person familiar with the art to modify the technical solutions documented in the preceding examples or to make equivalent substitutions for some of the technical features. Any modification, equivalent substitution and improvement made within the spirit and principles of the present disclosure should be included in the protection scope of the present disclosure.

1. A multi-policy intelligent scheduling method oriented to heterogeneous computing power, performed by an operating system kernel of a host machine, comprising:
setting an execution policy of a task based on heterogeneity of computing clusters, differences of computing tasks and a user requirement, and constructing a Markov decision process model by adopting a reinforcement learning manner combined with the execution policy;
wherein the computing clusters comprise one or more intelligent computing clusters, one or more high-performance computing clusters and one or more terminal idle computing clusters, the computing clusters comprise virtualized container clusters, a collection of the computing clusters is marked as C={C₀, C₁, . . . , C_{K}}, wherein C₀ represents a computing resource scheduling cluster, Cₖ(1≤k≤K) represents a cluster that performs the computing task, K represents a number of the computing clusters, each cluster Cₖ comprises a limited number of containers nₖ, and Cₖ={c₁, c₂, . . . , cₙ_{ₖ}} represents a set of containers configured in available resources;
a set of the tasks is marked as T={t₀, t₁, . . . , t_{N}}, wherein N is a total number of tasks in a time period, for any task tᵢϵT and for a container cₖϵCₖ located in Cₖ, cₖ=map(tᵢ), which indicates the task tᵢ is executed by the container cₖ, in response to determining that the container cₖ has been deployed, the task tᵢ is executed directly, in response to determining that the container cₖ has not been deployed, then cₖ=Ø, and acquiring a corresponding mirroring file from a mirroring repository of a container and starting the container;
the task tᵢ is marked as tᵢ={atᵢ, wtᵢ, dlᵢ dsᵢ, cᵢ^{k}}, wherein atᵢ represents an arrival time of the task the task tᵢ, wtᵢ represents a waiting time of the task tᵢ, dlᵢ represents an execution duration of the task tᵢ, whose value is −1 in response to determining no duration existing; dsᵢ represents data to be processed by the task tᵢ, cᵢ^{k} represents a set of containers on a kth cluster required by the task tᵢ to perform a calculation of the task; and an execution time of the task tᵢ is:
$$\\ {et}_{i}^{k} = \frac{{ds}_{i}}{{ER}_{{c}_{i}^{k}}}$$
wherein etᵢ^{k} represents the execution time of the task tᵢ, which is obtained by the data amount dsᵢ corresponding to the task tᵢ divided by a total processing rate
$$\\ {ER}_{{c}_{i}^{k}}$$
of data by an algorithm in the set of containers cᵢ^{k};
for a case of dlᵢ>0, a constraint is:
dlᵢ−atᵢ>wtᵢ+etᵢ^{k};
the Markov decision process model, combined with the execution policy, is represented by five elements (S, A, P, R, γ) of the reinforcement learning manner, wherein S represents a state space, A represents an action space, P represents a state transfer matrix, R represents a reward function, and γ represents a discount factor; the state space is used to reflect a state of the computing clusters; the action space is used to represent scheduling of one or more current tasks; the state transfer matrix is composed of probabilities of all state transfers in the state space according to actions in the action space in the Markov decision process model; the reward function is used to reflect execution policies of different tasks, and set based on the execution policies; the discount factor takes values between 0 and 1, the Markov decision process model considers both current rewards and future rewards, the discount factor represents that the future rewards is more, a discount is greater and a corresponding weight is smaller;
the execution policies comprise: a least cost policy, a shortest execution time policy, an optimal energy consumption policy and an optimal bandwidth policy;
the reward function comprises:
wherein an expression of a reward function for executing the least cost policy is:
$$\\ {r}_{n}^{1} = \frac{1}{1 + {e}^{\frac{{t}_{{n}_{}}^{1}}{max \{ {t}_{n}^{1} \}}}}$$
wherein a cost function is:
tₙ¹=dsᵢ×f_{c}^{k}+etₙ^{k}×fᵤ^{k}×rateᵢ;
wherein at a n-th stage of a period, tₙ¹ represents an operating cost of a subtask at the stage, comprising two parts: communication cost and computing cost, the communication cost is set as processed amount of data dsᵢ multiplied by a cost of unit data f_{c}^{k} of the cluster Cₖ, and the computing cost is an execution time etₙ^{k} multiplied by a cost of unit data fᵤ^{k} of the cluster Cₖ and then multiplied by a resource occupancy rate rateᵢ; when a cost is higher, an obtained reward is less, the reward function rₙ¹ for stage n is a monotonically decreasing function of tₙ¹;
wherein an expression of a reward function for executing the shortest execution time policy is:
$$\\ {r}_{n}^{2} = \frac{1}{1 + {e}^{\frac{{t}_{{n}_{}}^{2}}{max \{ {t}_{n}^{2} \}}}}$$
wherein a cost function is:
tₙ²=wtₙ+etₙ^{k},
wherein at a n-th stage in a period, tₙ² represents that a running time of the subtask, which is equal to a sum of a waiting time wtₙ and an execution time etₙ^{k}; wherein the running time is longer, the obtained reward is less, so the reward function rₙ² of stage n is a monotonically decreasing function of tₙ²;
wherein an expression of a reward function for executing the optimal energy consumption policy is:
$$\\ {r}_{n}^{3} = \frac{1}{1 + {e}^{\frac{{t}_{{n}_{}}^{3}}{max \{ {t}_{n}^{3} \}}}}$$
wherein a cost function is:
$$\\ {t}_{n}^{3} = {cp}_{n}^{k} + {gp}_{n}^{k}$$
$$\\ {cp}_{n}^{k} = {\sum }_{i ∈ H ( k )} {scp}_{i} \times {c\_rate}_{i}$$
$$\\ {gp}_{n}^{k} = {\sum }_{i ∈ H ( k )} {sgp}_{i} \times {g\_rate}_{i} ;$$
wherein at a n-th stage in a period, tₙ³ represents that a subtask energy consumption assessment, which is equal to a sum of a central processing unit (CPU) energy consumption assessment cpₙ^{k} and a graphics processing unit (GPU) energy consumption assessment gpₙ^{k}; CPU or GPU power consumption refers to CPU power consumption scpᵢ or GPU power consumption sgpᵢ of a server running the subtask within the cluster Cₖ multiplied by an average occupancy rate c_rateᵢ or g_rateᵢ; when a power consumption is higher, the obtained reward is less, the reward function rₙ³ for stage n is a monotonically decreasing function of tₙ³; and
wherein an expression of a reward function for executing the optimal bandwidth policy is:
$$\\ {r}_{n}^{4} = \frac{1}{1 + {e}^{\frac{{t}_{{n}_{}}^{4}}{max \{ {t}_{n}^{4} \}}}}$$
wherein a cost function is:
$$\\ {t}_{n}^{4} = {\sum }_{k > j} \frac{{ds}_{kj}}{{et}_{j}^{n}} ;$$
wherein dsₖⱼ indicates an amount of data transmitted from cluster Cₖ to cluster Cⱼ at stage n, etⱼⁿ represents an average computing time of cluster Cⱼ at the stage n, and an obtained rₙ⁴ represents average transmission bandwidth; when a bandwidth is larger, the obtained reward is less, the reward function rₙ⁴ for stage n is a monotonically decreasing function of tₙ⁴;
adopting a proximal policy optimization to solve an optimal task scheduling policy of the task input by the user based on the constructed Markov decision process model; and
scheduling the task to one or more corresponding computing clusters for execution based on the optimal task scheduling policy; comprising: scheduling the task to one or more waiting queues of the one or more corresponding computing clusters based on the optimal task scheduling policy, checking whether there is a corresponding container, in response to determining that the corresponding container exists, executing according to a corresponding queue, and in response to determining that the corresponding container does not exist, downloading a corresponding mirroring image of the compute cluster from the mirroring repository and starting to execute according to the corresponding queue.

2. The multi-policy intelligent scheduling method oriented to heterogeneous computing power according to claim 1, wherein the proximal policy optimization is based on a policy gradient manner, and by introducing dominance function and importance sampling, updating gradient as:
$$\\ ∇ \overline{R} = {E}_{τ \sim {p}_{{θ}^{′} ( τ )}} [ \frac{{p}_{θ}}{{p}_{{θ}^{′}}} A ] = {\sum }_{t = 1}^{T} \frac{{p}_{θ} ( {a}_{t} \vert {s}_{t} )}{{p}_{{θ}^{′}} ( {a}_{t} \vert {s}_{t} )} {A}_{t} ( {a}_{t} \vert {s}_{t} )$$
wherein the dominance function is:
$$\\ {A}_{t} ( {a}_{t} \vert {s}_{t} ) = {\sum }_{{t}^{′} > t} {γ}^{{t}^{′} - t} {r}_{{t}^{′}} - {V}_{∅} ( {s}_{t} ) ;$$
wherein
$$\\ {\sum }_{{t}^{′} > t} {γ}^{{t}^{′} - t} {r}_{{t}^{′}}$$
represents a total discount reward after an action point in a sequence τ in collected data; V_{Ø}(sₜ) represents an evaluation of a state sₜ by a Critic network, wherein the Critic network is used to estimate a total amount that obtained from the state sₜ to the end; and aₜ represents an execution policy corresponding to the state sₜ.

3. The multi-policy intelligent scheduling method oriented to heterogeneous computing power according to claim 2, wherein a training of the proximal policy optimization adopts following three neural networks:
a neural network Actor-new with a parameter θ, which is responsible for interacting with environment to collect batch data, and associating the batch data with a copy of θ for each update;
a neural network Actor-old with a parameter θ′, comprises correlation parameters of a policy parameter and data collected after interaction with the environment, which is equivalent to a q distribution in importance sampling; and
the evaluation neural network Critic with a parameter Ø, which updates an evaluation of a state by supervised learning based on the collected data.

4. A multi-policy intelligent scheduling apparatus oriented to heterogeneous computing power, comprising one or more processors, configured to realize the multi-policy intelligent scheduling method oriented to heterogeneous computing power according to claim 1.
